(19) United States
(12) Patent Application Publication
(10) Pub. No.: US 2015/0293047 A1
(43) Pub. Date: Oct. 15, 2015

(54) METHOD AND APPARATUS FOR DETERMINING WATER CONTENT OF OIL AND WATER MIXTURES BY MEASUREMENT OF SPECIFIC ADMITTANCE

(71) Applicant: Intevep, S.A., Caracas (VE)

(72) Inventors: Inigo Rotzer, Los Teques (VE); Alexander Molero, San Antonio de Los Altos (VE); Alexander Fuenmayor, Los Teques (VE); Beercheba Rondón, Caracas (VE); Nestor Caliz, Los Teques (VE)

(21) Appl. No.: 14/252,811

(22) Filed: Apr. 15, 2014

(51) Int. Cl. G01N 27/22

(52) U.S. Cl. CPC G01N 27/223

(57) ABSTRACT

A method for measuring water content of a mixture of oil and water includes a) generating a medium frequency signal (Vᵢ); b) passing the medium frequency signal (Vᵢ) through a frequency conversion circuit to produce a first measurement signal at a low frequency (V′ᵢ); c) passing the medium frequency signal (Vᵢ) through the mixture of oil and water to obtain an altered signal (Vₒ); d) passing the altered signal (Vₒ) to a frequency conversion circuit to produce an altered measurement signal at a low frequency (V′ₒ); and (e) determining water content of the oil and water mixture based upon amplitude and phase change of the altered measurement signal (V′ₒ) as compared to the first measurement signal (V′ᵢ).

### BACKGROUND OF THE INVENTION

The invention relates to measurement of water content in oil and water mixtures and, more particularly, to an apparatus and method for determining the water content in oil and water mixtures using measurement of specific admittance.

Mixtures of oil and water are frequently encountered in the industries of oil and gas well operations and production, and mixtures encountered include continuous phase oil mixtures, continuous phase water mixtures, oil-in water emulsions, water-in-oil emulsions, water-oil-gas mixtures and the like.

For numerous reasons related to handling of such liquid mixtures, it is useful to know the water content of the liquid mixture. A variety of differing techniques have been employed to measure the water content of these liquid mixtures.

One method and apparatus for making these measurements is disclosed in U.S. Pat. No. 5,260,667, issued Nov. 9, 1993. In this patent, directed primarily to emulsions, a basic determination of specific admittance is made and adjusted based upon temperature to produce a signal representative of the water content of the emulsion. This provided a useful approach. However, this approach was limited in its effectiveness by the need to filter the signals using additional hardware. Further, this approach is hindered by gain, phase and offset errors due to temperature drift, tolerance of the electronic components and aging, and correction of these issues requires additional electronic circuitry as well.

Previous approaches are complex in terms of the circuitry involved, and inaccurate due to temperature drifts and/or noise pickup. These deficiencies raise questions regarding accuracy and as a result, there is a need for a method and apparatus for measuring water content which are accurate, efficient, low frequency, temperature and noise stable.

### SUMMARY OF THE INVENTION

In accordance with the invention, a method is provided for measuring the water content of a mixture of oil and water which provides enhanced accuracy utilizing fewer and less expensive equipment.

A method for measuring water content of a mixture of oil and water, comprising the steps of a) generating a medium frequency signal (Vᵢ); b) passing the medium frequency signal (Vᵢ) through a frequency conversion circuit to produce a first measurement signal at a low frequency (V′ᵢ); c) passing the medium frequency signal (Vᵢ) through the mixture of oil and water to obtain an altered signal (Vₒ); d) passing the altered signal (Vₒ) to a frequency conversion circuit to produce an altered measurement signal at a low frequency (V′ₒ); and (e) determining water content of the oil and water mixture based upon amplitude and phase change of the altered measurement signal (V′ₒ) as compared to the first measurement signal (V′ᵢ).

In accordance with the invention, the altered signal can be filtered, and calibration techniques utilized, to produce a very accurate measurement of change in phase and amplitude of the signal and to determine the portion of this change which is attributable to the water and oil mixture and thereby obtain accurate determination of water content as desired.

In further accordance with the invention, the initial measurement of the altered signal produces a value of the admittance of the mixture through which the signal has been passed, and this admittance value can then be used as described herein to obtain the desired accurate determination of water content in the mixture.

### BRIEF DESCRIPTION OF THE DRAWINGS

A detailed description of preferred embodiments of the present invention follows, with reference to the attached drawings, wherein:

FIG. 1 is a block diagram of an apparatus according to the invention;

FIG. 2 is a schematic illustrating the process of the present invention;

FIG. 3 illustrates signal conditioning in accordance with the present invention; and

FIG. 4 is a block diagram of an autocalibration circuit in accordance with the present invention.

### DETAILED DESCRIPTION

The invention relates to a method and apparatus for determining water content of oil and water mixtures by measurement of specific admittance, particularly by measuring change in a signal after it has passed through the mixture. More specifically, the invention relates to a method and apparatus for measuring specific admittance of a mixture of oil and water using digital measurement of a medium frequency 1 MHz signal based on a sampling rate of just 10 kHz through the use of a frequency conversion circuit, which produces a much more accurate result with far less electronics and correction as was needed previously, for example in the system disclosed in U.S. Pat. No. 5,260,667.

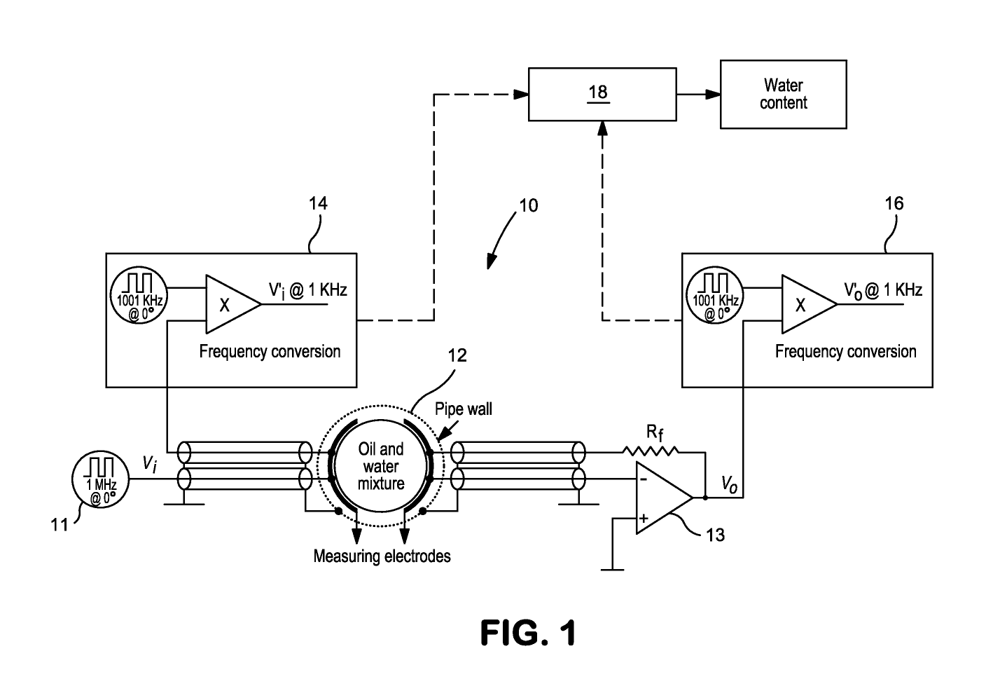

FIG. 1 shows a system 10 in accordance with the invention which is used for determining the water content of an oil and water mixture which typically will be contained in a pipeline 12 shown in cross section in FIG. 1. According to the invention, a signal (Vᵢ) is passed through electrodes which are inside of pipeline 12 and isolated from the wall of the pipeline, and through the mixture contained therein. The resulting signal received after having passed through the mixture, referred to as Vₒ, is analyzed to determine the desired water content. Signal Vᵢ has known amplitude, frequency and phase, and the change in amplitude and phase is proportional to the water content of the mixture.

According to the invention, while the signal Vᵢ is initially at a medium frequency, typically a frequency of 1 MHz, as is the altered signal Vₒ, signals of this frequency require a high sampling rate and more computational resources to properly analyze. In accordance with the invention, signals Vᵢ and Vₒ are mixed with an additional medium frequency reference signal to form a measurement signal that is passed to a low pass filter to obtain the low frequency component of the measurement signal. The low pass filter and frequency conversion circuit is schematically illustrated in FIG. 1 at reference numerals 14 and 16.

Signal Vᵢ is a sinusoidal signal, and passing this signal through the mixture of oil and water will alter the amplitude and phase of the signal. Measurement of the amplitude and phase of the signal at the input (Vᵢ) and output (Vₒ) therefore allows to quantify the phase and magnitude alterations induced by the mixture which can be used to calculate the water content of the mixture.

Thus, according to the invention, the output or altered signal Vₒ is processed by being mixed with a medium frequency reference signal to obtain a second measurement signal having two frequencies. This second measurement signal is then passed through another low pass filter/frequency conversion circuit 16 to remove the higher frequency component and obtain an altered signal having a low frequency V′ₒ.

The signals V′ᵢ and V′ₒ can then be compared to obtain the desired measurement of specific admittance which is proportional to the quantity of oil/water mixture to be determined.

A low pass filter which is part of the frequency conversion circuits 14, 16 of FIG. 1 is used to remove the higher frequency component, leaving only the low frequency component of the original and altered signal, typically having a frequency of 1 kHz.

To summarize, FIG. 1 shows pipeline 12 carrying a mixture of oil and water to be analyzed, and system 10 according to the invention, including a signal generator 11 for generating the medium frequency signal Vᵢ. A grounded signal processor 13 is also shown which can be used to change the measured variable (current to voltage) as discussed below.

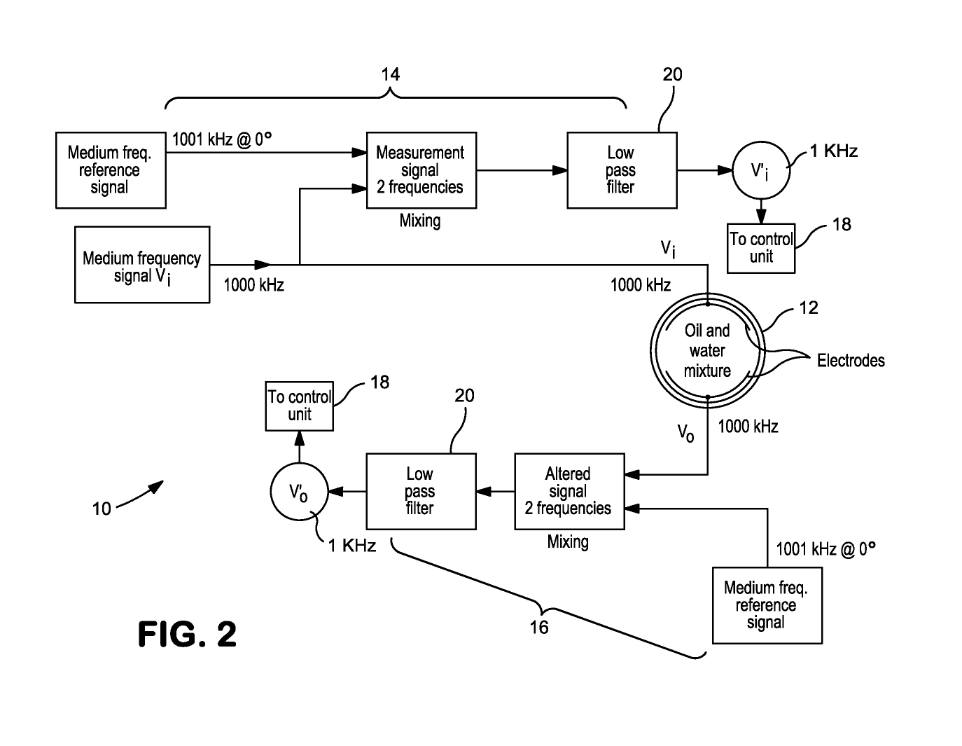

Referring also to FIG. 2, signal generator 11 is used to generate a medium frequency signal Vᵢ, for example having a frequency of 1 MHz, and this signal is passed both to frequency conversion circuit 14 and electrodes located inside pipeline 12.

At frequency conversion circuit 14, the signal is first mixed with a medium frequency reference signal and then passed through a low pass filter to remove the higher frequency component of the signal and produce a low frequency base signal for use in later determination of water content.

As explained herein, when signal Vᵢ passes through the pipeline 12, the mixture of oil and water alters the amplitude and phase of the signal such that altered signal Vₒ results from passing through the pipeline. This altered signal Vₒ is passed through frequency conversion circuit 16 where it is mixed with a medium frequency reference signal and then passed through a low pass filter to remove the higher frequency and create an altered measurement signal. The resulting low frequency signals from frequency conversion circuits 14, 16 are signals V′ᵢ and V′ₒ. These signals are then analyzed by a control unit 18, which produces a determination of water content based upon change in phase and amplitude of the altered signal.

FIG. 2 schematically illustrates this process.

According to the invention, initial analog signals determined in accordance with the above can be converted to digital signals by the frequency conversion circuits, and such digital signals can be used to provide an accurate indication of the water content in the oil/water mixture.

It has been found according to the Nyquist criteria that a minimum sampling rate required for making an analog to digital conversion is two times the bandwidth of the analog signal. Thus, the minimum sampling rate in accordance with the invention should be two times the frequency of the remaining altered signal, that is, 2 kHz. In prior disclosures, the sampling rate has been much higher than this value, which requires more computational power to process the digitized signal. The maximum sampling rate usable at the present invention is 10 kHz.

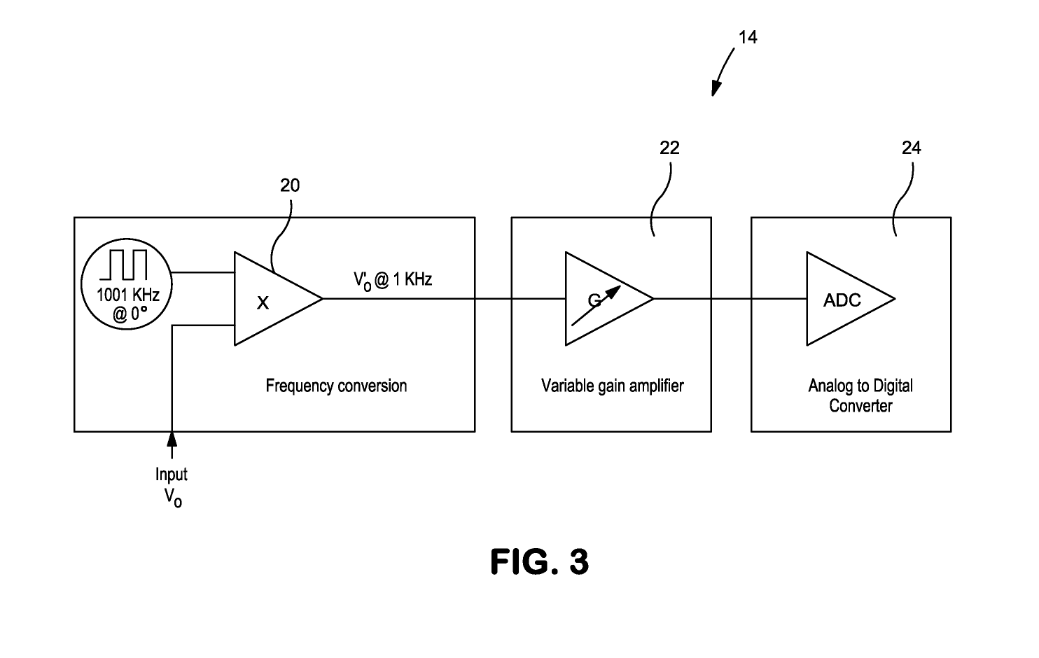

FIG. 3 further illustrates a preferred embodiment of frequency conversion circuit in accordance with the present invention. FIG. 3 shows this circuit as it relates to treating the Vₒ, but a similar circuit could be used for treating Vᵢ as well, and it is preferred to treat both signals in this manner.

FIG. 3 shows input in the form of altered signal Vₒ, mixed with the medium frequency reference signal and passed through low pass filter 20. From low pass filter 20, signal V′ₒ at 1 kHz can be passed to a variable gain amplifier 22 and an analog to digital converter 24 to produce a signal which can most easily be compared to a corresponding signal V′ᵢ to provide the desired measurement and accuracy for determining water content.

Variable gain amplifiers can be used to scale the amplitudes of the 1 kHz signals. FIG. 3 schematically illustrates this process, from filtering the second measurement signal to remove the medium frequency signal component, to variable gain amplification and then analog to digital conversion. It is preferred to get the amplitude to be as close as possible to the maximum allowable voltage at the input of the analog to digital converter.

To summarize the steps of the present invention, when it is desired to measure the water content of a mixture of oil and water, electronics in accordance with the invention are connected to electrodes located inside a portion of a pipeline carrying the mixture, and signals can be passed from one side to the other of the pipeline, and measurements of the signal as it is received passing through the mixture of oil and water in the pipeline can be taken to determine the desired parameter of the mixture contained in the pipeline.

In order to conduct this method, one signal is passed through the pipeline, preferably, a medium frequency signal having a frequency in the range of between about 500 kHz and about 1.5 MHz, preferably 1 MHz, because at 1 MHz the least significant variations in permittivity were observed. To measure the alteration in phase and amplitude of the mentioned signal caused by the oil and water mixture, these properties must be monitored at the input of the pipeline (Vᵢ) and at its output (Vₒ). For monitoring the signal, frequency conversion circuits are used to lower the frequency of Vᵢ and Vₒ. This is accomplished by mixing each of Vᵢ and Vₒ with a 1001 kHz reference signal and then treating the mixed signal using known frequency conversion circuitry. The higher frequency component can be filtered out using this known frequency conversion circuitry. The signal containing the remaining frequencies, V′ᵢ for the original signal and V′ₒ for the altered signal, can then be evaluated for changes in phase and amplitude, and these measurements allow a measurement of the admittance of the mixture contained within the pipeline. The admittance can then be utilized in relationships which are well known to a person skilled in the art to produce a determination of the water content of the mixture as desired. The relationships used to determine the water content of the mixture are advantageously programmed into the control unit in advance.

The electronics and method in accordance with the present invention include calibration prior to actual measurements, and the calibration can be used to correct for various different errors which could otherwise be present, and also to adjust the calculations to made in accordance with the invention depending upon whether the oil and water mixture has a continuous oil or water phase.

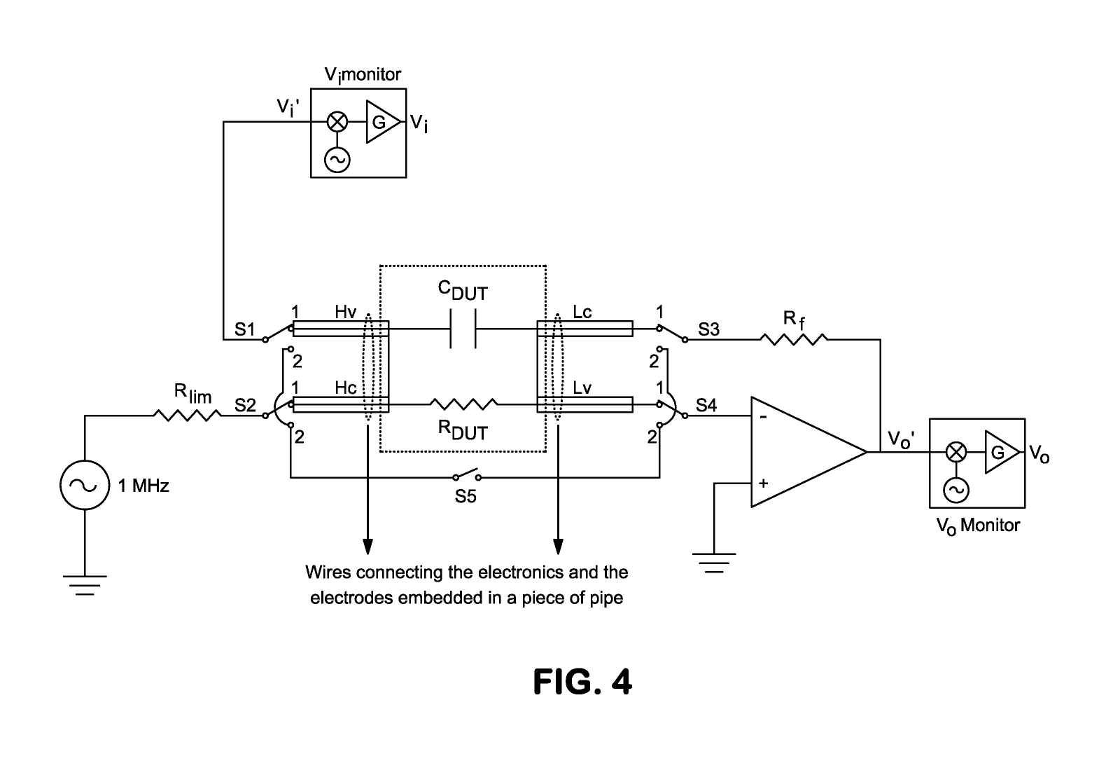

As previously mentioned, both amplitude and phase of the signals Vₒ and Vᵢ are measured in the digital domain using Fast Fourier Transform (FFT). To achieve accurate measurements, any error introduced by the electronics must be eliminated or at least be made negligible. This is the main purpose of the autocalibration circuit, which is illustrated in FIG. 4. In this embodiment, the considered sources of measurement errors are gain, offset and phase errors.

The phase difference (Df) between Vₒ and Vᵢ is one of the measurements of interest. Two factors influence the value of Df. The first factor is the reactive or imaginary part of the equivalent electrical model representing the water and oil mixture. This is the desired factor and the reason why Df is measured. A second component of phase change is caused by the frequency conversion and variable gain amplifier circuits. Each signal goes through a different electrical path and different amplifier stages and other electronic components. This can cause a phase mismatch between them. This phase mismatch is not related to the influence of the water and oil mixture and therefore represents an error. To get the maximum possible accuracy, this error must be addressed and preferably eliminated.

In FIG. 4, five switches (S1-55) are positioned to make the necessary electrical connections to calibrate the electronics. In FIG. 4 the oil and water mixture is represented by its equivalent electrical model, consisting of capacitor (CDUT) and resistor (RDUT) connected in parallel. With switches S1 through S4 configured in position 1, and S5 open, the condition is represented for making impedance measurements. For phase calibration, S1 through S4 are moved to position 2, and S5 is closed to short circuit the oil and water mixture. Under this condition the phase error introduced by the electronics is characterized. The phase error introduced by the connecting wires is measured using a different approach, which is not part of the present invention. Measurement of phase error due to connecting wires is known to a person skilled in the art.

A linear relationship is assumed between V′ᵢ and Vᵢ. This is also true for V′ₒ and Vₒ. The equation of a straight line best describes this linear relationship:

V′ₓ=VₓGₓ+bₓ (1)

where x is either i, representing the signal and electronics at the input of the oil and water mixture, or o for the signal and electronics at its output. G is the gain and b is the offset. The gain value is configured in the design stage of the electronic circuits. In practice, due to reasons such as temperature drift, tolerance and aging, the value of G can differ from the theoretical one. The offset b under ideal conditions would be zero. But it is well known that in practice the value of b is temperature dependent and different from zero. Since the offset is located at zero Hz in the frequency domain, this should not be a problem since the working frequencies of the electronics associated with the measurement process are at 1 kHz and 1 MHz. Even so, this factor is considered in Equation 1 above.

For determining the value of b, the input of each frequency conversion circuit is connected to the circuit ground. This forces Vx to be zero in Equation 1, and the measured value of V′x is only influenced by b.

For gauging the value of Gx, V′i and V′o are measured with the inputs of the frequency conversion circuits configured in two different circuit configurations.

For the first circuit configuration, the inputs of both frequency conversion circuits are disconnected from the rest of the electronics, shorted together and connected to an arbitrary voltage source. Such voltage source is dependent on the gain configured for the variable gain amplifier. Its gain dependent level must produce a voltage close to the maximum allowable input for the analog to digital converter (ADC). The accuracy and thermal drift of the arbitrary voltage source does not affect the correct calculation of Gx.

The following equation describes the above mentioned circuit configuration:

$$\frac{{V}_{o}^{′} - {b}_{o}}{{G}_{o}} = \frac{{V}_{i}^{′} - {b}_{i}}{{G}_{i}} \qquad ( 2 )$$

The second circuit configuration is the result of connecting a high precision resistor R (0.1% tolerance or better) with low thermal drift (5 ppm per ° C. or better) instead of the oil and water mixture. Under this condition, the following equation holds true:

$$\frac{1}{R} = - \frac{1}{{R}_{f}} \frac{\frac{{V}_{o}^{′} - {b}_{o}}{{G}_{o}}}{\frac{{V}_{i}^{′} - {b}_{i}}{{G}_{i}}} cos ( {θ}_{o} - {θ}_{i} ) \qquad ( 3 )$$

Rf is a resistor used to convert the current coming out from the oil and water mixture to voltage. Rf has a value which is known. Equations 2 and 3 are independent and have two unknown variables (gains Gi and Go). The process of gauging the values of Gx, by solving the two mentioned equations, and bx, by shorting to ground the inputs of the frequency conversion circuits, allows calculating the amplitude of the 1 MHz signal Vx, based on the amplitude measurement of the 1 kHz signal V′x. As mentioned, V′x amplitude is necessary for the water and oil mixture impedance computation. Thanks to the frequency conversion circuit, the amplitude of a 1 MHz sinusoidal signal can be measured with the help of an ADC with a minimum sampling rate of 2 kHz.

It should be appreciated that the whole calibration process relies only on the accuracy of a single electronic component, the precision resistor R. No further precision electronic components are required. The gain and offset calibration procedure described herein, maximizes the accuracy of the signal measured amplitude. Besides the error sources mentioned above, FFT also may add error due to incoherent sampling. This leads to spectral leakage in the frequency domain. The computation of Gx compensates for this specific error, and no extra hardware circuitry is necessary to warrant coherent sampling. This makes the accuracy of the measurement circuit independent of frequency changes in the 1 MHz and 1001 kHz signals and/or the oscillator controlling the sampling rate. To be sure that the proper correction values are applied, the autocalibration controlling algorithms can be triggered when the electronics temperature changes by more than 5° C.

It should be appreciated that the method and apparatus of the present invention determine water content by measuring admittance (Y), and that admittance is related to conductance as shown in the following relation.

$$Y = \frac{1}{Z} = B + j2π fC = \frac{1}{R} + j2π fC \qquad ( 4 )$$

In this relation, B is the conductance, f is frequency, C is capacitance R is resistance and j is a constant. Conductance is determined as being the real part of Y. Since the cell constant of the measurement head is known, the conductivity can be computed to be used in water content calculations when a continuous water phase is detected. For continuous phase oil, the imaginary part of Y is measured. Under these circumstances, because the excitation frequency f is known, C can be obtained. Based upon the relationship between capacitance and permittivity for the measurement head used, the permittivity is calculated, and can be correlated to water content.

Based upon the foregoing, it should be clear that the method and apparatus of the present invention can readily adapt to measure water content in mixtures where either the water or the oil phase happens to be continuous.

It should be appreciated that in the present invention, since an excitation frequency of 1 MHz is used, the impedance of the oil and water mixture is reduced, thus obtaining greater values of the current signal at the output. This reduces the specific requirements of the instrument amplifier. In accordance with the present invention, an input bias current of 100 pA is sufficient to maintain measurement error less than 0.0025%. This is accomplished without guard drivers or anything similar for reducing leakage currents caused by cable capacitance and the like.

It should be appreciated that based upon the foregoing, a system and apparatus have been provided which allow for simple and accurate measurement of water content in mixtures of water and oil, and that the method and apparatus function with a reduced amount of electronics and the like as compared to known approaches for obtaining this measurement.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications which are within its spirit and scope as defined by the claims.

What is claimed is:

1. A method for measuring water content of a mixture of oil and water, comprising the steps of:
a) generating a medium frequency signal (Vᵢ);
b) passing the medium frequency signal (Vᵢ) through a frequency conversion circuit to produce a first measurement signal at a low frequency (V′ᵢ);
c) passing the medium frequency signal (Vᵢ) through the mixture of oil and water to obtain an altered signal (Vₒ);
d) passing the altered signal (Vₒ) to a frequency conversion circuit to produce an altered measurement signal at a low frequency (V′ₒ); and
(e) determining water content of the oil and water mixture based upon amplitude and phase change of the altered measurement signal (V′ₒ) as compared to the first measurement signal (V′ᵢ).

2. The method of claim 1, wherein step b) comprises combining the medium frequency signal (Vᵢ) with a medium frequency reference signal to produce a measurement signal having two frequencies, and passing the measurement signal through a low pass filter to produce the first measurement signal at a low frequency (V′ᵢ).

3. The method of claim 2, wherein the medium frequency signal (Vᵢ) has a frequency of 1,000 kHz, and wherein the medium frequency reference signal has a frequency of 1,001 kHz.

4. The method of claim 2, wherein the first measurement signal (V′ᵢ) has a frequency of 1 kHz.

5. The method of claim 1 wherein step d) comprises combining the altered signal (Vₒ) with a medium frequency reference signal to produce an altered measurement signal having two frequencies, and passing the altered measurement signal through a low pass filter to produce the altered measurement signal at low frequency (V′ₒ).

6. The method of claim 5, wherein the altered signal (Vₒ) has a frequency of 500 kHz-1.5 MHz, and wherein the medium frequency signal has a frequency of 1,001 kHz.

7. The method of claim 5, wherein the altered measurement signal (V′ₒ) has a frequency of 1 kHz.

8. The method of claim 1, wherein measurement values of the altered measurement signal at low frequency (V′ₒ) are obtained at a sampling rate of between 2 kHz and 10 kHz.

9. The method of claim 1, wherein amplitude and phase of the 1 kHz measurement signals (V′ᵢ) and (V′ₒ) are measured in a digital domain using fast Fourier transform.

10. A system for measuring water content of a mixture of oil and water, comprising:
a signal generator for generating a medium frequency signal (Vᵢ) and converting it to a low frequency measurement signal (V′ᵢ);
contacts located inside a piece of pipeline carrying the mixture of oil and water for passing the medium frequency signal (Vᵢ) through the mixture of oil and water to produce an altered signal (Vₒ);
a second frequency conversion circuit for receiving the altered signal (Vₒ) and converting it to a low frequency altered measurement signal (V′ₒ); and
a control unit programmed to analyze the low frequency measurement signal (V′ᵢ) and the low frequency altered measurement signal (V′ₒ) to determine water content of the mixture of oil and water.
